(19) United States
(12) Patent Application Publication
(10) Pub. No.: US 2025/0015644 A1
(43) Pub. Date: Jan. 9, 2025

(54) TRANSVERSE FLUX MACHINE

(71) Applicant: Steering Solutions IP Holding Corporation, Saginaw, MI (US)

(72) Inventors: Shuvajit Das, Sterling Heights, MI (US); Alejandro J. Pina Ortega, Midland, MI (US); Anik Chowdhury, Auburn Hills, MI (US); Rong Yang, Troy, MI (US)

(21) Appl. No.: 18/738,536

(22) Filed: Jun. 10, 2024

Related U.S. Application Data
(60) Provisional application No. 63/525,064, filed on Jul. 5, 2023.

(51) Int. Cl. H02K 1/14; B62D 5/00; H02K 21/14; H02K 21/22

(52) U.S. Cl. CPC H02K 1/145; B62D 5/006; H02K 21/145; H02K 21/227; H02K 2201/12

(57) ABSTRACT

A transverse flux machine (TFM) includes: a rotor configured to rotate about an axis and having a plurality of pairs of permanent magnets, with flux concentrating and flux diverging cores alternatively placed between the permanent magnets, each of the pairs of permanent magnets arranged to generate a magnetic flux in a circumferential direction into the flux concentrating core and away from the flux diverging core; and a stator including a transverse flux core configured to direct the magnetic flux in each of a radial direction and an axial direction. The rotor further includes a non-magnetic material located between the permanent magnets of each of the pairs of the permanent magnets, adjacent to the flux concentrating core and opposite from the stator, the non-magnetic material having a thickness (TH) in a radial direction. A steer-by-wire system for a vehicle includes a handwheel actuator including a TFM coupled to a steering wheel.

### CROSS REFERENCE TO RELATED APPLICATIONS

This U.S. utility patent application claims the benefit of U.S. Provisional Patent Application No. 63/525,064, filed Jul. 5, 2023, the contents of which is incorporated herein by reference in its entirety.

### TECHNICAL FIELD

This disclosure relates to transverse flux electric machines. This disclosure also relates to applications of such transverse flux electric machines in a handwheel actuator of a steering system for a vehicle.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Steer by wire (SbW) is a direct evolution of the EPS system where there is no mechanical coupling between the handwheel and the steering rack. An EPS system may include a single actuator with the sole purpose of providing assist to the driver during steering actions. However, on the SbW system, there may be two electric actuators/motors with different functionalities. The electric actuator attached to the rack in a SbW system is called the roadwheel actuator (RWA), whereas the actuator on the driver side is known as the handwheel actuator (HWA). The RWA has the same assist providing function as an EPS system actuator. The HWA on the other hand acts more as a feedback motor rather than providing assist to the driver. In the absence of the HWA the handwheel on a SbW system would just freewheel because of the absence of any mechanical coupling/friction. The HWA, because of its' functionality opens a wide array of design related opportunities.

Based on their functionality, the torque speed curves of the different actuators used in steering systems may also be different. The very different operating domains of the EPS/RWA and the HWA motivates design exploration for HWA technology.

### SUMMARY

This disclosure relates generally to transverse flux electric machines.

An aspect of the disclosed embodiments includes a transverse flux machine (TFM). The TFM includes: a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core. The TFM also includes a stator including a transverse flux core configured to direct the magnetic flux in each of a radial direction and an axial direction. The rotor further includes a non-magnetic material located between the permanent magnets of each of the pairs of the permanent magnets, adjacent to the flux concentrating core and opposite from the stator, the non-magnetic material having a thickness (TH) in a radial direction.

Another aspect of the disclosed embodiments includes a dual-wound transverse flux machine (TFM). The dual-wound TFM includes a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core. The dual-wound TFM also includes a stator including a plurality of transverse flux cores, each of the transverse flux cores configured to direct the magnetic flux in each of a radial direction and an axial direction; and a first ring winding and a second ring winding each disposed in a shared transverse flux core of the plurality of transverse flux cores, and each configured to conduct a corresponding current.

Another aspect of the disclosed embodiments includes a steer-by-wire system for a vehicle. The steer-by-wire system includes a handwheel actuator coupled to apply a torque to a steering wheel. The handwheel actuator includes a transverse flux machine (TFM). The TFM includes: a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core; and a stator including a transverse flux core configured to direct a magnetic flux in each of a radial direction and an axial direction.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an electric power steering (EPS) system according to the principles of the present disclosure.

FIG. 2 generally illustrates an EPS system according to the principles of the present disclosure.

FIG. 3 generally illustrates a steer-by-wire (SbW) steering system according to the principles of the present disclosure.

FIG. 4 is a schematic diagram of a dual wound motor drive system according to the principles of the present disclosure.

FIG. 5 shows a graph illustrating torque-speed curves of steering system actuators according to the principles of the present disclosure.

FIG. 6 shows a graph illustrating a torque-speed curve of a direct drive handwheel actuator in a SbW steering system.

FIG. 7 shows a cross-sectional diagram of a radial flux machine (RFM) according to the principles of the present disclosure.

FIG. 8 shows a cross-sectional diagram of an axial flux machine (AFM) according to the principles of the present disclosure.

FIG. 9 shows a cross-sectional diagram of a transverse flux machine (TFM) according to the principles of the present disclosure.

FIG. 10 shows a perspective fragmentary view of a U-core TFM according to the principles of the present disclosure.

FIG. 11 shows a perspective fragmentary view of a U-core TFM with iron bridges according to the principles of the present disclosure.

FIG. 12 shows a perspective fragmentary view of a hook-shaped TFM according to the principles of the present disclosure.

FIG. 13 shows a perspective fragmentary view of a U-core TFM with a flux-concentrating inner rotor, according to the principles of the present disclosure.

FIG. 14 shows a perspective fragmentary view of a TFM with claw pole configuration, according to the principles of the present disclosure.

FIG. 15 shows a perspective fragmentary view of a TFM with a flux-concentrating outer rotor and a single-piece stator, according to the principles of the present disclosure.

FIG. 16 shows a perspective view of a stator in an external rotor TFM according to the principles of the present disclosure.

FIG. 17 shows a perspective view of a stator in an internal rotor TFM according to the principles of the present disclosure.

FIG. 18 shows a perspective fragmentary view illustrating flux leakage of in an internal rotor TFM at an axial end and opposite from the stator, according to the principles of the present disclosure.

FIG. 19 shows a cross-sectional view illustrating flux leakage between stators of different phases in an internal rotor TFM, according to the principles of the present disclosure.

FIG. 20 shows a perspective fragmentary view illustrating flux leakage of in an external rotor TFM at an axial end and opposite from the stator, according to the principles of the present disclosure.

FIG. 21 shows a fragmentary cross-sectional diagram of in an internal rotor TFM, according to the principles of the present disclosure.

FIG. 22 shows a fragmentary cross-sectional diagram of in an external rotor TFM, according to the principles of the present disclosure.

FIG. 23A shows a fragmentary cross-sectional diagram of a first internal rotor TFM of the present disclosure, showing flux leakage opposite from the stator.

FIG. 23B shows a perspective fragmentary view of the first internal rotor TFM of FIG. 23A.

FIG. 24A shows a fragmentary cross-sectional diagram of a second internal rotor TFM of the present disclosure, showing flux leakage opposite from the stator.

FIG. 24B shows a perspective fragmentary view of the second internal rotor TFM of FIG. 24A.

FIG. 25 shows a graph of Average torque (Nm) vs. BetaCc (degrees) of an internal rotor TFM and for various thicknesses of non-magnetic material (TH).

FIG. 26 shows a graph of Torque Ripple (%) vs. BetaCc (degrees) of an internal rotor TFM and for various thicknesses of non-magnetic material (TH).

FIG. 27 shows a graph of Average torque (Nm) and Torque Ripple (%) vs. thickness (mm) of non-magnetic material (TH) of an internal rotor TFM of the present disclosure.

FIG. 28 shows a shows a perspective fragmentary view of an internal rotor TFM of the present disclosure and with non-magnetic material (TH) having a thickness TH=0, showing leakage flux opposite from the stator.

FIG. 29 shows a shows a perspective fragmentary view of an internal rotor TFM of the present disclosure and with non-magnetic material (TH) having a thickness TH=1.5 mm, showing leakage flux opposite from the stator.

FIG. 30 shows a graph of Average torque (Nm) vs. BetaDc (degrees) of an internal rotor TFM of the present disclosure, and for various different values of BetaCc (2, 3, and 4 degrees).

FIG. 31 shows a graph of Torque ripple (%) vs. BetaDc (degrees) of an internal rotor TFM of the present disclosure, and for various different values of BetaCc (2, 3, and 4 degrees).

FIG. 32 shows a cross-sectional diagram of a permanent magnetic synchronous machine (PMSM) with 3 phase groups in a 9 s/6 p configuration coupled to three different electronic control units (ECUs).

FIG. 33 shows a cross-sectional diagram of a permanent magnetic synchronous machine (PMSM) with 4 phase groups in a 12 s/8 p configuration coupled to two different electronic control units (ECUs).

FIG. 34 shows a perspective view of a stator in an external rotor TFM with a dual-wound configuration and with three rings stacked axially and shifted circumferentially from one-another.

FIG. 35 shows a perspective view of a single stator ring of an external rotor TFM with a dual-wound configuration.

FIG. 36 shows a perspective fragmentary view of a single stator within a single-wound TFM and with round cross-sectional wire windings, according to the present disclosure.

FIG. 37 shows a perspective fragmentary view of a single stator within a dual-wound TFM and with rectangular cross-sectional wire windings, according to the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

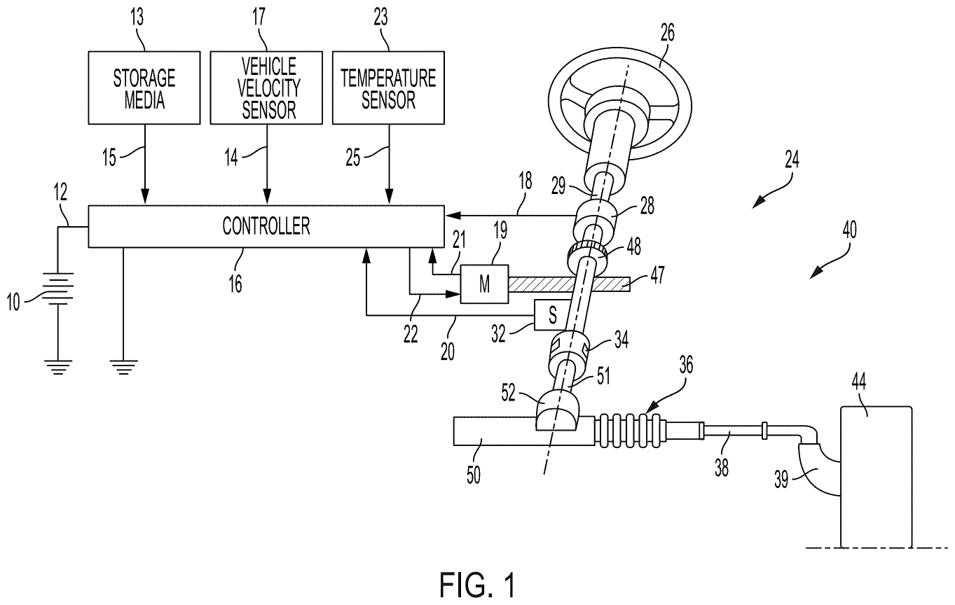

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system generally designated by reference numeral 24 and includes the controller 16 and an electric machine, which could be a permanent magnet synchronous motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed @m may be determined as the derivative of the motor position Om with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 16 may include input signal processing and filtering to enable accurate sampling and conversion or acquisitions of such signals from communications interfaces.

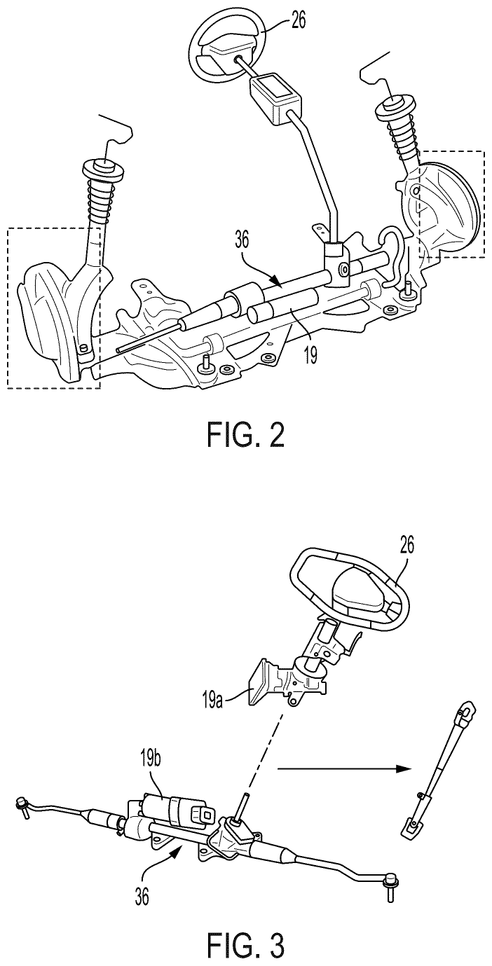

FIG. 2 generally illustrates an EPS system, and FIG. 3 generally illustrates a steer-by-wire (SbW) steering system. The EPS system of FIG. 2 may be similar or identical to the EPS system 40 of FIG. 1, except with the motor 19 mounted directly to the steering mechanism 36. The SbW system of FIG. 3 may be similar or identical to the EPS system 40 of FIG. 1, except without any physical linkage between the steering wheel 26 and the steerable wheels 44, and with two separate and independent motors 19a, 19b. As shown, the SbW system includes a first motor 19a, also called a roadwheel actuator (RWA), and a second motor 19b, also called a handwheel actuator (HWA). The HWA 19b is configured to provide a torque to the steering wheel 26 for providing haptic feedback to a driver.

SbW is a direct evolution of the EPS system where there is no mechanical coupling between the steering wheel 26 and the steering rack. As seen in FIG. 2, an EPS system may include a single actuator 19 with the sole purpose of providing assist to the driver during steering actions. However, on the SbW system, there are two electric actuators/motors with different functionalities. The electric actuator attached to the steering mechanism 36 in a SbW system is called the roadwheel actuator (RWA) 19a, whereas the actuator on the driver side is known as the handwheel actuator (HWA) 19b. The RWA 19a may provide the same assist function as the actuator 19 in an EPS system. The HWA 19b, on the other hand, acts more as a feedback motor rather than providing assist to the driver. In the absence of the HWA 19b the handwheel on a SbW system would just freewheel because of the absence of any mechanical coupling/friction. The HWA 19b, because of its' functionality, opens a wide array of design-related opportunities.

As used herein, variables with a tilde (˜) above the variable symbol represent an approximation, which may be determined by a mathematical calculation, a lookup table, etc. Variables with a bar above the variable symbol represent a vector quantity. Variables with a superscript star (*) represent commands or desired set point values.

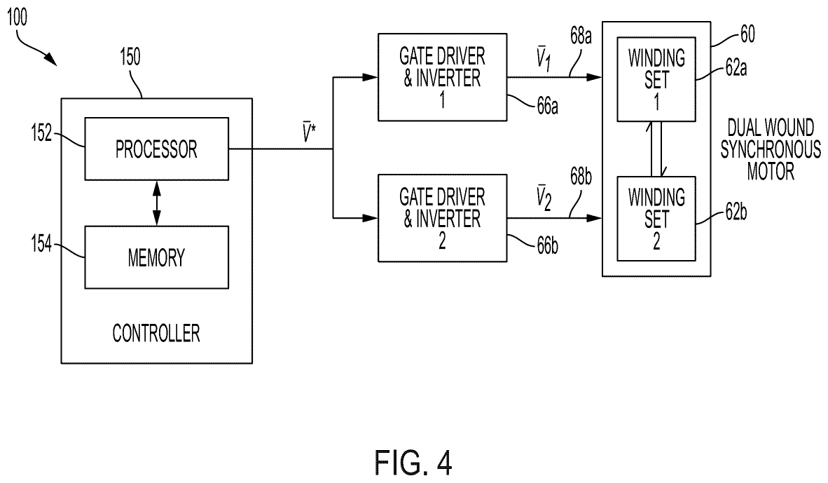

FIG. 4 illustrates an electric motor drive system 100 having a dual wound permanent magnet synchronous motor (DW-PMSM), also called a dual wound synchronous machine (DWSM) or a dual wound motor 60, power converters 66a and 66b (each including a gate driver and a corresponding inverter), and a motor controller 70 (also referred to as a controller). The dual wound motor 60 may be used in any number of applications, such as for the motor 19 in the steering motion control system 24 shown in FIG. 1. The power converters 66a and 66b may include several switching devices, such as field effect transistors (FETs) for switching high current loads and gate driver circuitry for operating the switching devices. The motor controller 70 receives a motor torque command T*ₑ from a motion controller 80, such as, for example, a power steering controller.

The motor controller 70 may generate the voltage command V̅* based on the motor torque command T*ₑ from the motion controller 80, and using any feedforward control technique. For example, the motor controller 70 may include a voltage command generator (not shown) to generate the voltage command V̅* using one or more optimizations and/or to cause the electric motor drive system to satisfy one or more operating constraints, such as constraints on voltage and/or current produced by or supplied to the electric motor drive system. The feedforward voltage control technique may include a technique provided in the present disclosure, although other feedforward control techniques may be used.

The dual wound motor 60 includes a first winding set 62a and a second winding set 62b that is electrically independent of the first winding set 62a. The dual wound motor 60 is capable of generating electromagnetic torque by energizing either or both winding sets 62a, 62b. The two winding sets 62a and 62b may each include three phases and thus, each of the two winding sets 62a, 62b may include three phase windings. Alternatively, each of the winding sets 62a, 62b may include any number of winding phases, such as five or seven phases. In some embodiments, the dual wound motor 60 is a poly-phase permanent magnet synchronous machine (PMSM). Each of the winding sets 62a, 62b may function individually, and the dual wound motor 60 can be operated by energizing either or both of the winding sets 62a, 62b.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

The dual wound motor 60 includes a first winding set 62a and a second winding set 62b that is electrically independent of the first winding set 62a. The dual wound motor 60 is capable of generating electromagnetic torque by energizing either or both winding sets 62a, 62b. The two winding sets 62a and 62b may each include three phases and thus, each of the two winding sets 62a, 62b may include three phase windings. Alternatively, each of the winding sets 62a, 62b may include any number of winding phases, such as five or seven phases. In some embodiments, the dual wound motor 60 is a poly-phase PMSM. However, the dual wound motor 60 may be any type of synchronous machine, such as a poly-phase wound-field synchronous machine. Additionally, the dual wound motor 60 may have a salient pole configuration or a non-salient pole configuration, depending on the placement of the permanent magnets or field winding on the rotor. Each of the winding sets 62a, 62b may function individually, and the dual wound motor 60 can be operated by energizing either or both of the winding sets 62a, 62b.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

In some embodiments, the electric motor drive system 100 may include a motor controller, such as controller 150, as is generally illustrated in FIG. 4. The controller 150 generates a voltage command V̅* which may include d-axis and q-axis constituent parts, V*_{d}, V*_{q}, respectively. For example, the controller 150 may generate the voltage command V̅* based on a motor torque command T*ₑ. Each of the power converters 66a, 66b applies an output voltage V̅₁, V̅₂ to the corresponding one of the winding sets 62a, 62b based on the voltage command V̅*.

The controller 150 may include any suitable controller. The controller 150 may be configured to control, for example, various functions of the vehicle systems described herein. The controller 150 may include a processor 152 and a memory 154. The processor 152 may include any suitable processor, such as those described herein. Additionally, or alternatively, the controller 150 may include any suitable number of processors, in addition to or other than the processor 152. The memory 154 may comprise a single disk or a plurality of disks (e.g., hard drives), and includes a storage management module that manages one or more partitions within the memory 154. In some embodiments, memory 154 may include flash memory, semiconductor (solid state) memory or the like. The memory 154 may include Random Access Memory (RAM), a Read-Only Memory (ROM), or a combination thereof. The memory 154 may include instructions that, when executed by the processor 152, cause the processor 152 to, at least, control various functions of the steering system and/or any other suitable function, including those of the systems and methods described herein.

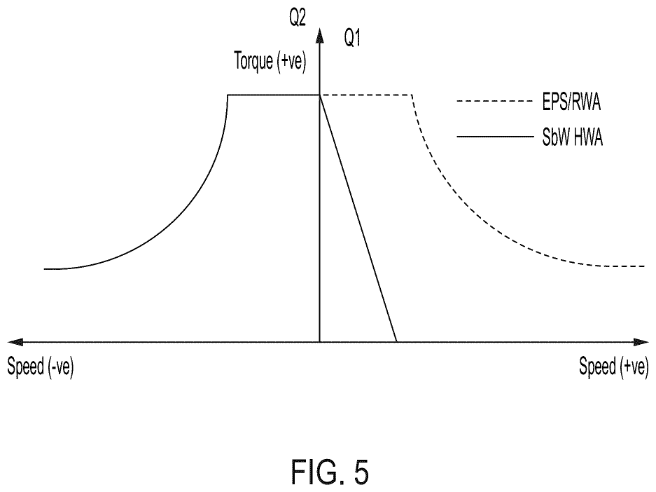

FIG. 5 shows a graph illustrating torque-speed curves of steering system actuators 19, 19a, and 19b. Based on their functionality, the different steering system actuators 19, 19a, 19b have different speed curves. As indicated by the dashed line in FIG. 5, the EPS actuator 19 and the RWA 19a in a SbW each work in the first quadrant (Q1) of the torque-speed curve. The positive direction of speed in Q1 suggests that the actuator acts in the same direction as the driver's handwheel motion and provides assist. However, as indicated by the solid line, the HWA 19b of the SbW system operates mostly in the second quadrant (Q2) of the torque-speed curve. The HWA 19b moves opposite (speed −ve) to the driver's handwheel motion and provides feedback to the driver. This feedback may be necessary to provide generic steering feel and road condition feedback to the driver. Additionally, some low-speed assist (Q1 operation) might also be required from the HWA 19b, as seen in FIG. 5.

The HWA 19b may include an electric motor coupled apply torque to the steering wheel 26 configurations, such as a Worm gear drive, Belt drive, and/or a Direct drive. For the worm gear and belt driven cases, low torque of about 3 Newton meters (Nm) and high speed of about 3000 revolutions per minute (RPM). PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems.

Based on their functionality, the torque speed curves of the different actuators used in steering systems also changes. As shown in FIG. 5, the EPS actuator and the RWA in a SbW system, each work in the first quadrant (Q1) of the torque-speed curve. The positive direction of speed in Q1 suggests that the actuator acts in the same direction as the driver's handwheel motion and provides assist. However, the SbW HWA operates mostly in the second quadrant (Q2) of the torque speed curve. The HWA moves opposite (speed-ve) to the driver's handwheel motion and provides feedback to the driver. This feedback is necessary to provide generic steering feel and road condition feedback to the driver. Moreover, some low-speed assist (Q1 operation) might also be required from the HWA, as seen in FIG. 5. The very different operating domains of the EPS/RWA and the HWA motivates design exploration for HWA technology.

The HWA 19b may include an electric motor coupled apply torque to the steering wheel 26 configurations, such as a Worm gear drive, Belt drive, and/or a Direct drive. For the worm gear and belt driven cases, low torque (˜3 Nm) and high speed (˜3000 rpm) PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems. For the direct drive case, high torque (˜30 Nm for egress/ingress) and low speed (˜200-300 rpm) actuators are required. The number of mechanical components decrease for the direct drive architecture, which in turn has the potential to reduce cost and weight. Moreover, a reduction in weight is directly linked to range efficiency or mileage (miles/gallon) increment. However, traditional PMSMs need to be redesigned for the high torque and low speed output requirement of the direct drive architecture.

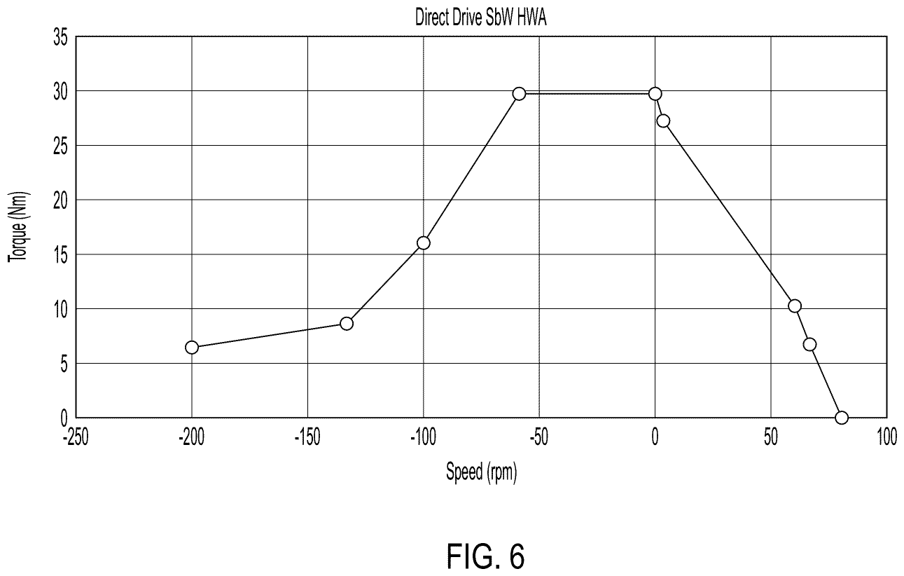

FIG. 6 shows a graph illustrating torque-speed curves of the HWA 19b in a SbW steering system, with a direct drive configuration (1:1 gear ratio). As shown, the HWA 19b generally operates with a speed of between −200 and +80 revolutions per minute (RPM), and produces a torque of between 0 and about 30 Newton meters (Nm). Transverse flux machines have the potential to perform in this low-speed high torque direct drive application.

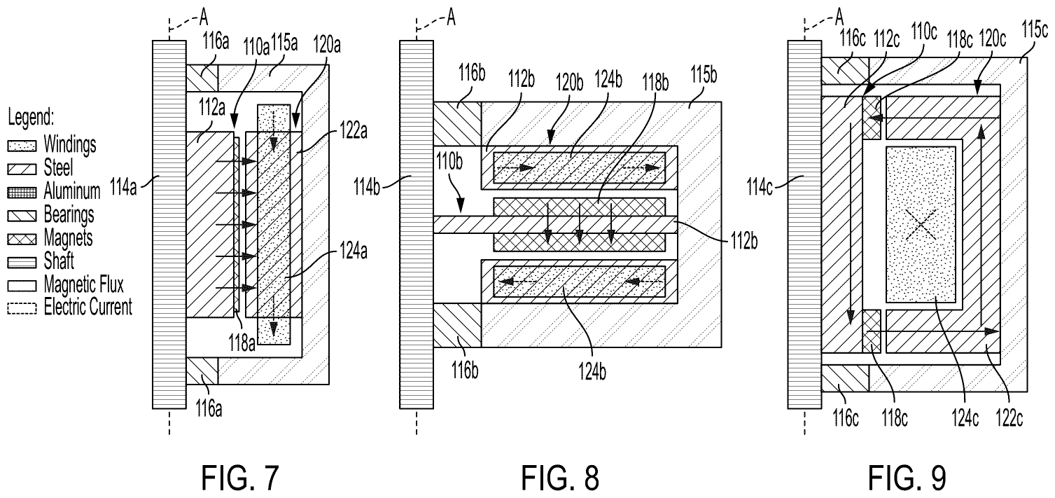

FIG. 7 shows a cross-sectional diagram of a radial flux machine (RFM). FIG. 8 shows a cross-sectional diagram of an axial flux machine (AFM). FIG. 9 shows a cross-sectional diagram of a transverse flux machine (TFM). Each of the RFM, AFM, and TFM devices includes a shaft configured to rotate about an axis A. Classification between the RFM, AFM, and TFM configurations may be made based on direction of magnetic flux.

The RFM of FIG. 7 includes a first rotor 110a having a first rotor core 112a attached to rotate with a first shaft 114a about an axis A. The first rotor 110a is located within a first housing 115a and the first shaft 114a extends through and out of the first housing 115a and is supported by a pair of first bearings 116a. A set of first permanent magnets 118a is attached to the first rotor core 112a and produces a magnetic flux that extends radially outwardly. The RFM of FIG. 7 also includes a first stator 120a having a first stator core 122a with a set of first windings 124a extending therethrough and carrying electric current in an axial direction, parallel to the axis A, and perpendicular to the magnetic flux.

The AFM of FIG. 8 includes a second rotor 110b having a second rotor core 112b attached to rotate with a second shaft 114b about an axis A. The second rotor 110b is located within a second housing 115b and the second shaft 114b extends through and out of the second housing 115b and is supported by a pair of second bearings 116b. A set of second permanent magnets 118b is attached to the second rotor core 112b and produces a magnetic flux that extends in an axial direction, parallel to the axis A. The AFM of FIG. 8 also includes a second stator 120b having a second stator core 122b with a set of second windings 124b extending therethrough and carrying electric current in a radial direction, perpendicular to the axis A, and perpendicular to the magnetic flux.

The TFM of FIG. 9 includes a third rotor 110c having a third rotor core 112c attached to rotate with a third shaft 114c about an axis A. The third rotor 110c is located within a third housing 115c and the third shaft 114c extends through and out of the third housing 115c and is supported by a pair of third bearings 116c. A set of third permanent magnets 118c is attached to the third rotor core 112c and produces a magnetic flux that extends radially inwardly at a first location, axially through the third rotor core 112c, and radially outwardly at a second location spaced apart axially apart from the first location. The TFM of FIG. 9 also includes a third stator 120c having a third stator core 122c with a set of third windings 124c extending therethrough and carrying electric current in an circumferential direction, perpendicular to the axis A, and perpendicular to the magnetic flux. As shown, the third stator core 122c defines a U-shape, with open ends aligned with the third permanent magnets 118c at the first and second locations for providing, with the third rotor core 112c, a closed rectangular path of the magnetic flux.

FIGS. 7-9 show the flux direction in the three machine topologies. For the RFM, the flux moves radially in the airgap, whereas for the AFM the flux moves axially from the stator to rotor and vice versa. However, as seen in FIG. 9 for the TFM, the flux moves both in the radial and the axial directions. Even though several topologies of TFM can be identified from the literature, 3D (radial and axial) flux paths are a common feature across different topologies. TFMs are known for their higher volumetric and gravimetric power densities compared to radial flux machines. AFMs and TFMs are known to have comparable power densities. However, the simplicity of the ring windings in a TFM has the potential to case manufacturing process and save cost.

As shown in FIG. 6, the magnetic flux in the RFM extends primarily in a radial direction, perpendicularly to the axis A. As shown in FIG. 7, the magnetic flux in the AFM extends primarily in an axial direction, parallel to the axis A. As shown in FIG. 8 the magnetic flux in the TFM defines a closed loop path, with portions extending in a radial direction, perpendicularly to the axis A, and with other portions extending in an axial direction, parallel to the axis A. The RFM, AFM, and TFM configurations may each provide different volumetric and gravimetric power densities. The TFM configuration may be especially well suited for low speed and high torque operation.

The present disclosure provides a Transverse flux machine (TFM) topology for a direct drive SbW HWA architecture. Transverse flux machines have the potential to provide significant power density advantages over the traditional radial flux machines in the low-speed high torque region of operation of a direct drive SbW HWA. Generic design guidelines of TFMs are given below. Traditional RFMs can be laminated in the radial X-Y plane to accommodate their 2D flux paths and reduce eddy current losses at high frequencies of operation. AFMs can be laminated as well in the axial X-Z plane to assist the axial travel of the flux from the stator to rotor and vice versa. However, As seen in FIG. 3(c), for a TFM the flux moves in both radial and axial direction. If a TFM were to be laminated, it would need to have both X-Y and X-Z direction laminations depending on the core location and intended direction of flux travel. This would severely complicate the manufacturing process of the TFM. In order to avoid complications and ensure 3D flux travel in the TFM cores, soft magnetic core (SMC) material is chosen here. SMC is insulated iron particles compacted into the shape of the cores. Electrical insulation among the iron particles of a compacted SMC core significantly reduces the eddy current loss at higher frequencies of operation. The conclusions drawn in this document are equally applicable to a TFM made of laminated steel.

Several TFM topologies are provided, with different performance areas where they excel. TFM designs generally indicate a trend towards increasing volumetric torque density. However, for steering applications, the actuator may be subjected to much stricter constraints of torque ripple, cogging torque, friction loss and so on. Additionally, manufacturing case may be an important criterion.

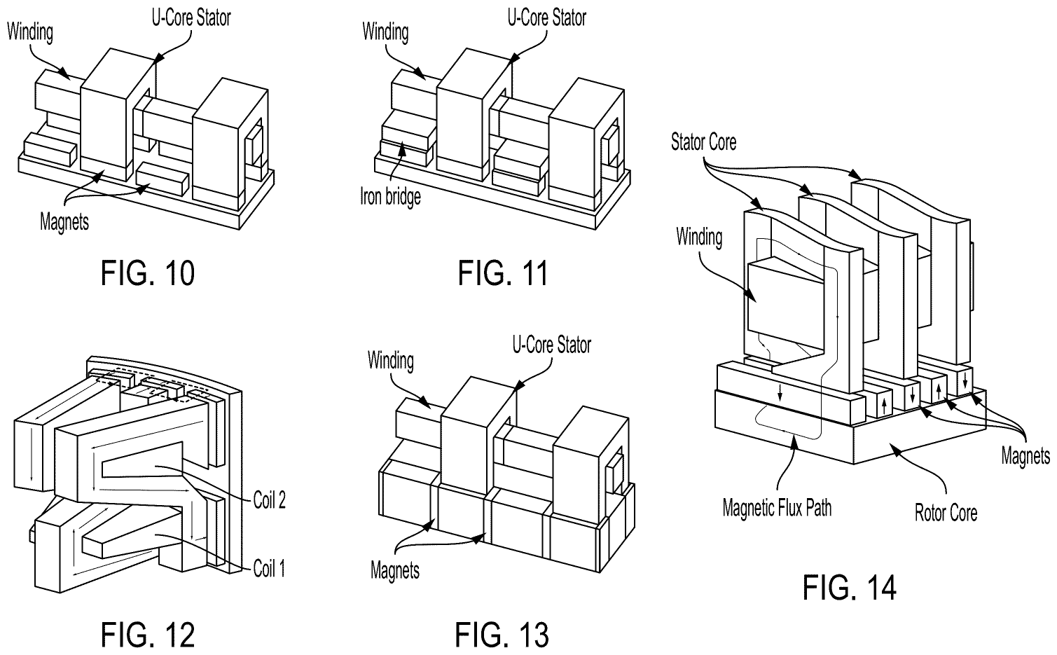

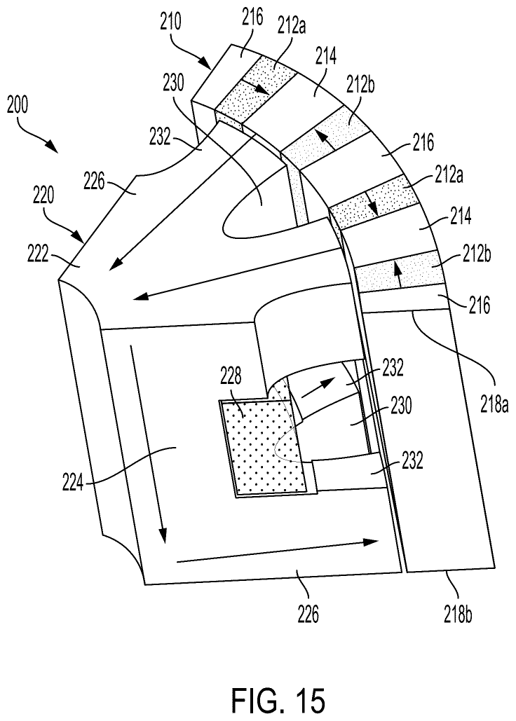

FIGS. 10-15 show various different topologies for a TFM. FIG. 10 shows a perspective fragmentary view of a U-core TFM. FIG. 11 shows a perspective fragmentary view of a U-core TFM with iron bridges. FIG. 12 shows a perspective fragmentary view of a hook-shaped TFM. FIG. 13 shows a perspective fragmentary view of a U-core TFM with a flux-concentrating inner rotor. FIG. 14 shows a perspective fragmentary view of a TFM with claw pole configuration. FIG. 15 shows a perspective fragmentary view of a TFM with a flux-concentrating outer rotor and a single-piece stator.

Reducing the number of pieces in the TFM may simplify the manufacturing process. Moreover, flux concentrating rotor structures display higher power densities and reduced magnet weight compared to other rotor topologies. Furthermore, the ring winding structure of the TFMs simplifies the winding process compared to needle wound radial flux machines. The TFM design shown in FIG. 15 may be advantageous for ease of manufacturing provided by the topology. It can be stacked axially and space shifted circumferentially to form a multiphase machine.

As shown, FIG. 15 presents a first TFM 200 having an external rotor configuration, with a first rotor 210 that is configured to rotate about an axis, with the rotor extending annularly about an internal stator assembly 220. FIG. 15 shows a 45-degree segment of the first TFM 200, with labels indicating magnetic flux. However, the complete first TFM 200 would include eight of such segments. The first rotor 210 includes a plurality of pairs of first permanent magnets 212a, 212b arranged at regular angular intervals and configured to produce magnetic flux in a circumferential direction therebetween. The first rotor 210 also includes a plurality of first flux concentrating cores 214 located between the first permanent magnets 212a, 212b of each of the pairs of first permanent magnets 212a, 212b and configured to conduct the magnetic flux therebetween. The first rotor 210 also includes a plurality of first flux diverging cores 216, each located between adjacent pairs of the first permanent magnets 212a, 212b. The first rotor 210 has a tubular shape and extends between a first axial end 218a and a second axial end 218b.

As also shown in FIG. 15, the internal stator assembly 220 includes an internal stator core 222 having a U-shaped cross-section with an inner cylindrical portion 224 and a pair of arms 226 extending radially outwardly from each end of the inner cylindrical portion 224 and toward the first rotor 210. A winding 228 extends in circumferential direction through the center of the U-shaped cross-section of the internal stator core 222 and conducts electrical current in the circumferential direction.

As shown, each arm 226 of the internal stator core 222 includes an arc-shaped recess 230 to define two radial-extending protrusions 232 that are angularly spaced apart to align with adjacent ones of the first flux concentrating cores 214 and the first flux diverging cores 216. In this way, magnetic flux is conducted from each of the first flux concentrating cores 214 adjacent the first axial end 218, across an airgap and into the radial-extending protrusions 232 of the internal stator core 222 adjacent thereto. The magnetic flux is directed into the inner cylindrical portion 224 of the internal stator core 222 where it continues in an axial direction. The magnetic flux is also directed out of the inner cylindrical portion 224 of the internal stator core 222 and radially outwardly through the arms 226 of the internal stator core 222 adjacent to the second axial end 218b, where it crosses the airgap into a corresponding ones of the first flux diverging cores 216. The magnetic flux continues through corresponding ones of the first permanent magnets 212a, 212b and then back into the first flux concentrating cores 214, thereby completing a closed path.

A TFM may be particularly well suited for direct drive low speed operation. The TFM may include a modular, spatially shifted three-phase stator architecture. The TFM may include a simple ring winding with inner stator topology. The TFM may provide a relatively low phase resistance, independent of number of stator slots and rotor poles. The TFM may include an outer rotor structure with high volumetric and gravimetric torque density. The TFM may be relatively easily and efficiently manufactured and may provide suitable performance for a variety of applications in an EPS and/or SbW system.

The phase resistance and the coil cross-section in a ring wound TFM are independent of the number of poles which enables higher torque density in TFMs compared to RFMs. Moreover, for some applications, such as a direct drive HWA in a SbW system, the operating speed is relatively low. This indicates that the fundamental electrical frequency of operation will be within a reasonable range, even if a higher pole number TFM is chosen. For example, for a 12 slot 8 pole SbW HWA with a gear ratio of 11:1, the fundamental frequency is 166.67 Hz at 2500 motor rpm. On the other hand, for a TFM with 100 poles and a direct drive structure, the fundamental frequency is 189.39 Hz at 227.27 motor rpm. The limiting number of poles (Pₘₐₓ) for a TFM can be calculated using equation (1):

$${n}_{limit} = \frac{120 {f}_{e , max}}{{P}_{max}} \qquad ( 1 )$$

where nₗᵢₘᵢₜ is the maximum motor speed in rpm, f_{e,max} is the maximum fundamental electrical frequency that can be handled by the motor drive.

Moreover, despite higher number of poles in TFMs the phase resistance does not increase which can offer reduced copper loss and thus improve efficiency and thermal performance.

### Inner Rotor/Outer Rotor Topology

The general sizing equation of a TFM can be written as in equation (2):

$${P}_{R} = \frac{m}{2} \frac{1}{1 + {K}_{phi}} {K}_{e} {K}_{i} {K}_{p} {K}_{L} η {B}_{g} A \frac{f}{p} {λ}_{o}^{2} {D}_{o}^{2} {L}_{e} \qquad ( 2 )$$

where P_{R} is the rated output power, Kₚₕᵢ is the ratio of electrical loading on rotor and stator (Kₚₕᵢ may be equal to zero), m is the number of phases, Kₑ is the BEMF factor incorporating the winding distribution factor Kw and the per unit portion of the total air gap area spanned by the salient poles of the machine (if any), Kᵢ is the current waveform factor, Kₚ is the electrical power waveform factor, K_{L} is the ratio of the stack length Lₑ vs. the diameter of the airgap surface D_{g}, n is the machine efficiency, B_{g} is the airgap flux density, A is the total electrical loading, f is the driver frequency, p is the number of pole pairs, Dₒ is the outer diameter of the machine and λ₀ is the ratio between D_{g} and Dₒ.

As evident from equation (2), the rated power and thus the torque output of the TFM is directly proportional to the square of the outer diameter of the machine Do. Substituting D_{g}/Dₒ in place of λ₀ it can be shown from (2) that the output power directly relates to the square of Dg. Going from an inner rotor TFM to an outer rotor TFM, the diameter of the airgap surface can be increased with better space utilization. This leads to higher volumetric torque density in outer rotor TFMs. Moreover, in outer rotor TFMs the winding process is comparatively simpler. Both outer and inner rotor TFMs are systematically optimized in accordance with the present disclosure.

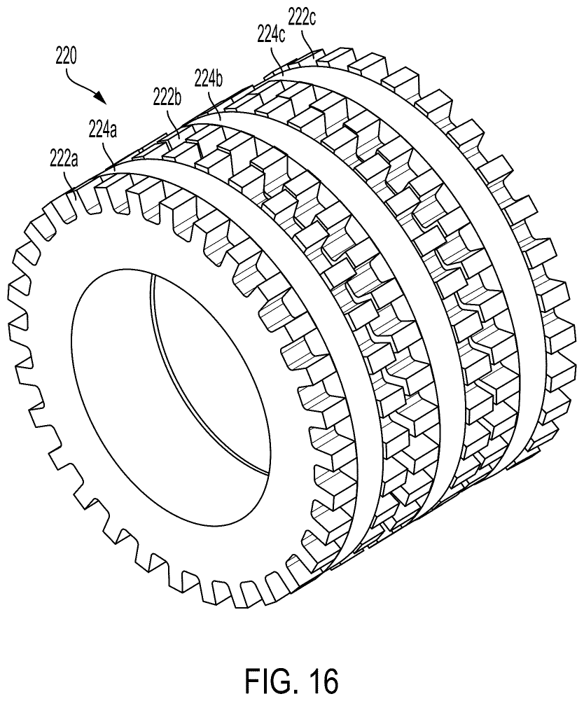

FIG. 16 shows a perspective view of the internal stator assembly 220 for an external rotor TFM, which is configured to have the rotor (not shown) disposed annularly thereabout. The internal stator assembly 220 includes three internal stator cores 222a, 222b, 222c, including an A-phase internal stator core 222a, a B-phase internal stator core 222b, and a C-phase internal stator core 222c. The three internal stator cores 222a, 222b, 222c each have similar or identical ring shapes that are stacked axially and shifted circumferentially from one-another. Each of the three internal stator cores 222a, 222b, 222c of the internal stator assembly 220 contains a corresponding winding 224a, 224b, 224c of a corresponding phase, and which extends circumferentially therethrough. Each of the three internal stator cores 222a, 222b, 222c of the internal stator assembly 220 also defines a plurality of radial-extending protrusions at regular angular intervals and extending radially outwardly.

The stacked assembly of the TFM stator leads to inherent asymmetry issues. As shown in FIG. 16, the B-phase internal stator core 222b is stacked between the A-phase internal stator core 222a and the C-phase internal stator core 222c in a 3-phase TFM. The A-phase internal stator core 222a and the C-phase internal stator core 222c may each be called exterior cores because of their location adjacent to an axial end of the stator assembly. The B-phase internal stator core 222b may be called an interior stator core, because of its location spaced apart from the axial end of the stator assembly.

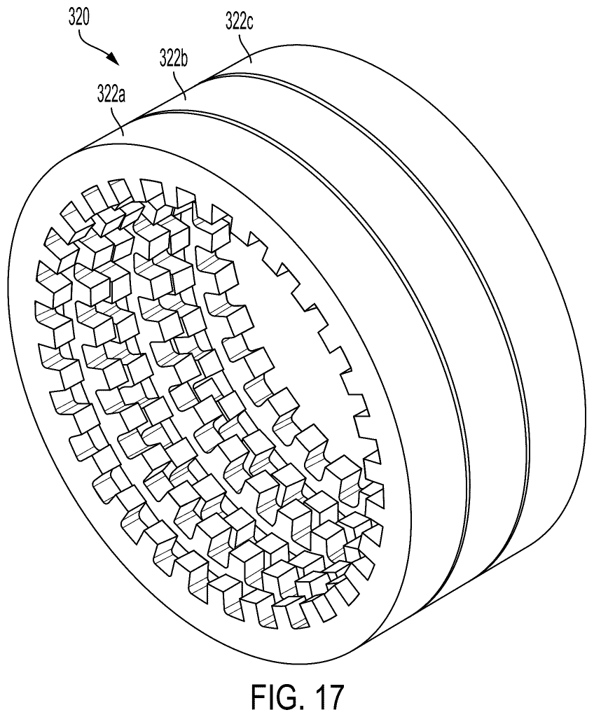

FIG. 17 shows a perspective view of an external stator assembly 320 for an internal rotor TFM, which is configured to be disposed annularly about a rotor (not shown). external stator assembly 320 includes three external stator cores 322a, 322b, 322c, including an A-phase external stator core 322a, a B-phase external stator core 322b, and a C-phase external stator core 322c. The three external stator cores 322a, 322b, 322c each have similar or identical ring shapes that are stacked axially and shifted circumferentially from one-another. Each of the three external stator cores 322a, 322b, 322c of the external stator assembly 320 may contain a corresponding winding (not shown in FIG. 17) of a corresponding phase, and extending circumferentially therethrough. Each of the three external stator cores 322a, 322b, 322c of the external stator assembly 320 also defines a plurality of radial-extending protrusions at regular angular intervals and extending radially inwardly.

Several different factors may affect the design of a TFM. Such design factors may include: topology selection and manufacturing challenges; material selection; number of poles; Inner/Outer rotor (i.e. internal rotor or external rotor configuration); multiphysics performance; and 3-dimensional (3D) simulations, which may be computationally expensive.

### Flux Leakage

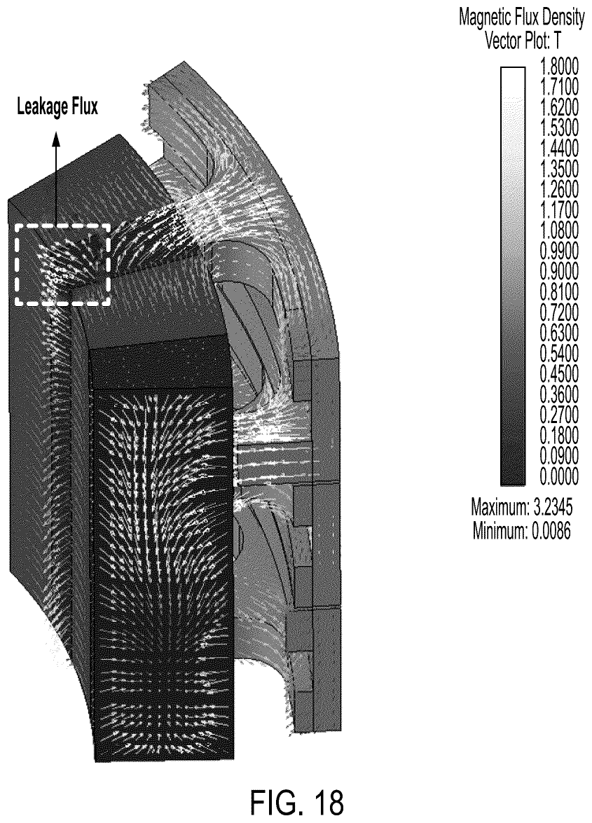

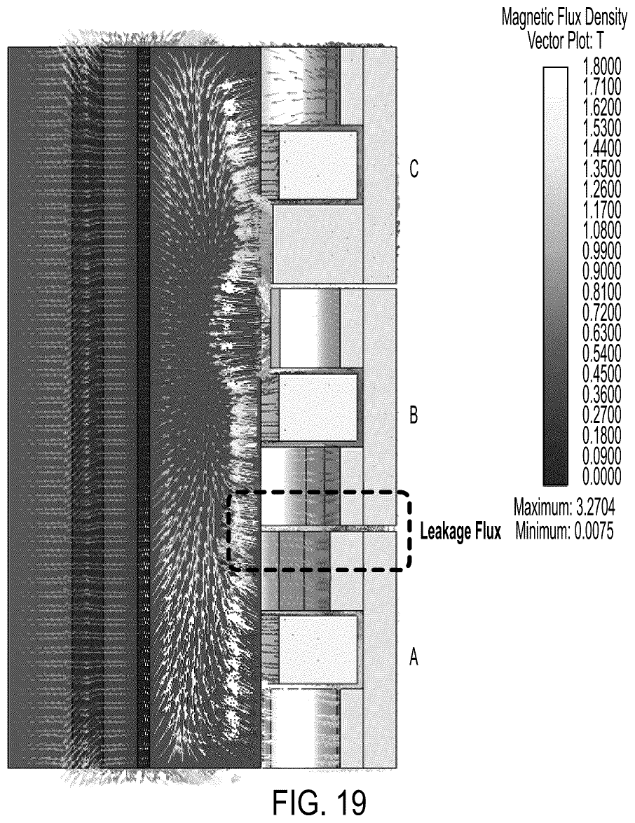

Despite their several benefits, TFMs because of the complex 3D nature of their flux paths suffer from flux leakage issues. Amount of flux leakage varies from one topology to another. Moreover, flux leakage is highly dependent on the number of poles in the TFM. FIGS. 18-19 show examples of the leakages happening in a TFM rotor and stacked stator structure. These leakages if left untreated will increase the magnet material weight in the optimized machine and thus will increase cost. A rotor flux leakage reduction method is proposed in this ROI.

Transverse flux machines have built in leakage issues because of the 3D nature of the flux path. Rotor leakages present on the flux concentrating core opposite the airgap (i.e. opposite from the stator), as shown in FIG. 18. Stator-to-stator leakages may be present in a modular stator architecture, as shown in FIG. 19. A modular stator structure with ring-shaped windings may give rise to asymmetric electromagnetic behavior among the stators of a multi-phase machine, such as a three-phase machine.

### Flux Leakage Reduction

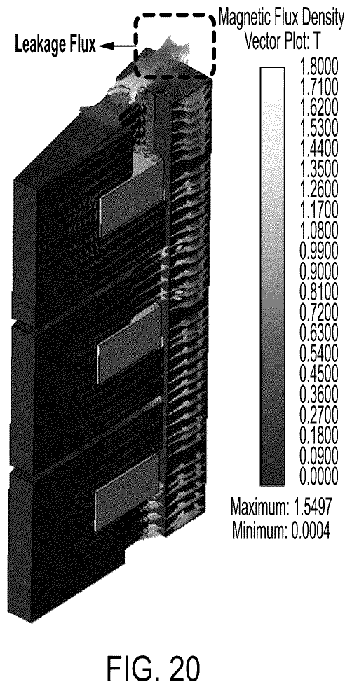

FIGS. 18 and 20 each show rotor flux leakages for inner and outer rotor topologies, respectively. The inner rotor TFM in FIG. 18 has a 20-pole structure, and the outer rotor TFM in FIG. 20 has a 60-pole structure. Rotor leakage is present in the TFM, on the opposite side of the airgap, irrespective of the topology (inner/outer rotor) and pole number.

The present disclosure provides TFMs 300, 400 having design features that are configured to reduce rotor flux leakage.

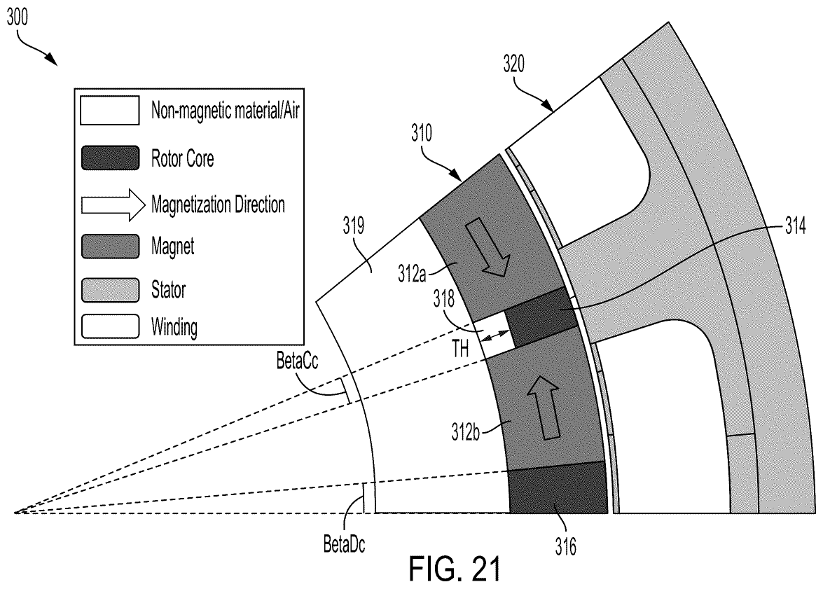

FIG. 21 shows a fragmentary cross-sectional diagram of a second TFM 300 having an internal rotor configuration. The second TFM 300 includes the external stator assembly 320 and a second rotor 310. The second rotor 310 may be similar or identical to the first rotor 210, except for differences described herein.

The second rotor 310 includes a plurality of pairs of second permanent magnets 312a, 312b arranged at regular angular intervals and configured to produce magnetic flux in a circumferential direction therebetween. The second rotor 310 also includes a plurality of second flux concentrating cores 314 located between the second permanent magnets 312a, 312b of each of the pairs of second permanent magnets 312a, 312b and configured to conduct the magnetic flux therebetween. As shown, the magnetization of the second permanent magnets 312a, 312b are each directed inwardly, into a corresponding one of the second flux concentrating cores 314. The second rotor 310 also includes a plurality of second flux diverging cores 316, each located between adjacent pairs of the second permanent magnets 312a, 312b.

The second flux concentrating cores 314 each define a first angular spread BetaCc, and the second flux diverging cores 316, each define a second angular spread BetaDc. In some embodiments, the first angular spread BetaCc of the second flux concentrating cores 314 may be not equal to the second angular spread BetaDc of the second flux diverging cores 316. For example, the first angular spread BetaCc of the second flux concentrating cores 314 may be greater than the second angular spread BetaDc of the second flux diverging cores 316.

The second rotor 310 also includes a first non-magnetic portion 318 of non-magnetic material located between the second permanent magnets 312a, 312b of each of the pairs of second permanent magnets 312a, 312b and adjacent to each of the second flux concentrating cores 314. The first non-magnetic portion 318 may include a non-magnetic solid material, such as Aluminum or epoxy. Alternatively or additionally, the first non-magnetic portion 318 may include space filled with ambient air. The first non-magnetic portions 318 are each located opposite from the external stator assembly 320, with a corresponding one of the second flux concentrating cores 314 disposed between each of the first non-magnetic portions 318 and the external stator assembly 320. The non-magnetic material of the first non-magnetic portions 318 defines a thickness (TH) in a radial direction. In some embodiments, the thickness (TH) may be at least about 1.5 mm. However, the thickness (TH) may have a different value, depending on design requirements.

The second rotor 310 may also include a first rotor housing 319 (not shown on FIG. 21), with the second permanent magnets 312a, 312b, the second flux concentrating cores 314, and the second flux diverging cores 316 attached thereto, on an outer surface thereof. The first rotor housing 319 housing may have a generally cylindrical or tubular shape that is attached to a motor shaft. In some embodiments, the first rotor housing 319 may protrude radially outwardly to define the first non-magnetic portions 318. In addition to minimizing flux leakage, the first non-magnetic portions 318 may be helpful during assembly of the second rotor 310. For example, the protrusions that define the first non-magnetic portions 318 may help in correct placement of the second permanent magnets 312a, 312b, the second flux concentrating cores 314, and the second flux diverging cores 316 during the assembly process.

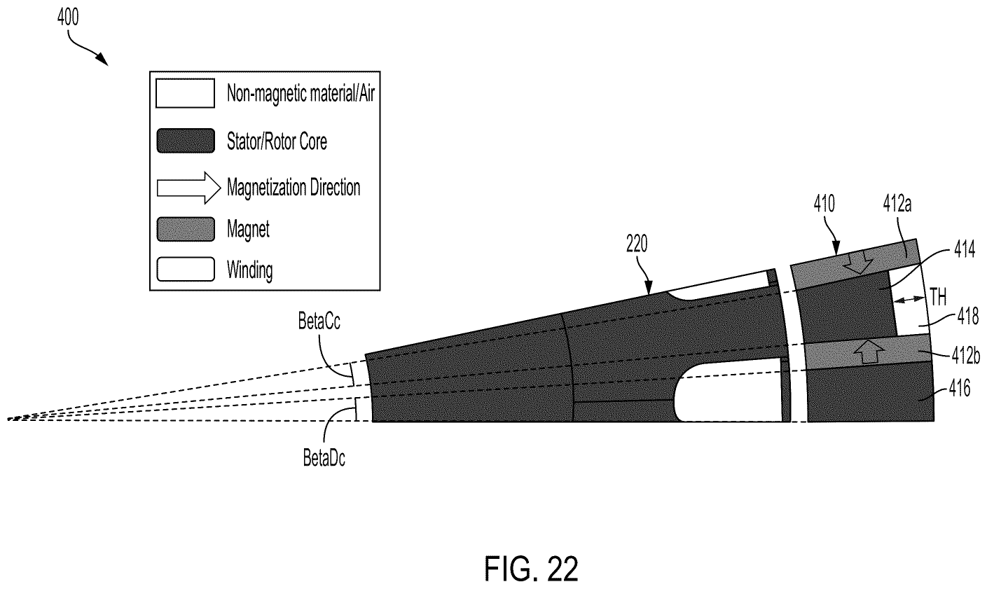

FIG. 22 shows a fragmentary cross-sectional diagram of a third TFM 400 having an external rotor configuration. The third TFM 400 includes the internal stator assembly 220 and a third rotor 410. The third rotor 410 may be similar or identical to the third rotor 410, except for differences described herein.

The third rotor 410 includes a plurality of pairs of third permanent magnets 412a, 412b arranged at regular angular intervals and configured to produce magnetic flux in a circumferential direction therebetween. The third rotor 410 also includes a plurality of third flux concentrating cores 414 located between the third permanent magnets 412a, 412b of each of the pairs of third permanent magnets 412a, 412b and configured to conduct the magnetic flux therebetween. As shown, the magnetization of the third permanent magnets 412a, 412b are each directed inwardly, into a corresponding one of the third flux concentrating cores 414. The third rotor 410 also includes a plurality of third flux diverging cores 416, each located between adjacent pairs of the third permanent magnets 412a, 412b.

The third flux concentrating cores 414 each define a first angular spread BetaCc, and the third flux diverging cores 416, each define a second angular spread BetaDc. In some embodiments, the first angular spread BetaCc of the third flux concentrating cores 414 may be not equal to the second angular spread BetaDc of the third flux diverging cores 416. For example, the first angular spread BetaCc of the third flux concentrating cores 414 may be greater than the second angular spread BetaDc of the third flux diverging cores 416.

The third rotor 410 also includes a second non-magnetic portion 418 of non-magnetic material located between the third permanent magnets 412a, 412b of each of the pairs of third permanent magnets 412a, 412b and adjacent to each of the third flux concentrating cores 414. The second non-magnetic portion 418 may include a non-magnetic solid material, such as Aluminum or epoxy. Alternatively or additionally, the second non-magnetic portion 418 may include space filled with ambient air. The second non-magnetic portions 418 are each located opposite from the internal stator assembly 220, with a corresponding one of the third flux concentrating cores 414 disposed between each of the second non-magnetic portions 418 and the internal stator assembly 220. The non-magnetic material of the second non-magnetic portions 418 defines a thickness (TH) in a radial direction. In some embodiments, the thickness (TH) may be at least about 1.5 mm. However, the thickness (TH) may have a different value, depending on design requirements.

The third rotor 410 may also include a second rotor housing (not shown on FIG. 22), with the third permanent magnets 412a, 412b, third flux concentrating cores 414, and the third flux diverging cores 416, attached thereto, on an inner surface thereof. The second rotor housing may have a generally tubular shape that is attached to a motor shaft. In some embodiments, the second rotor housing may protrude radially inwardly to define the second non-magnetic portions 418. In addition to minimizing flux leakage, this second non-magnetic portion 418 may be helpful during assembly of the third rotor 410. For example, the protrusion that defines the second non-magnetic portion 418 may help in correct placement of the third permanent magnets 412a, 412b, the third flux concentrating cores 414, and the third flux diverging cores 416 during the assembly process.

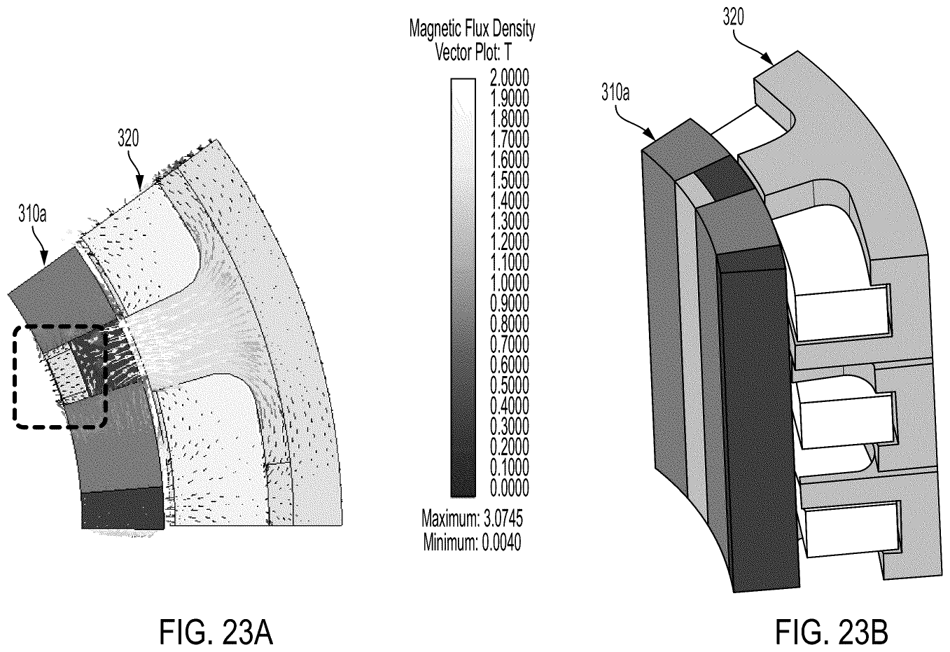

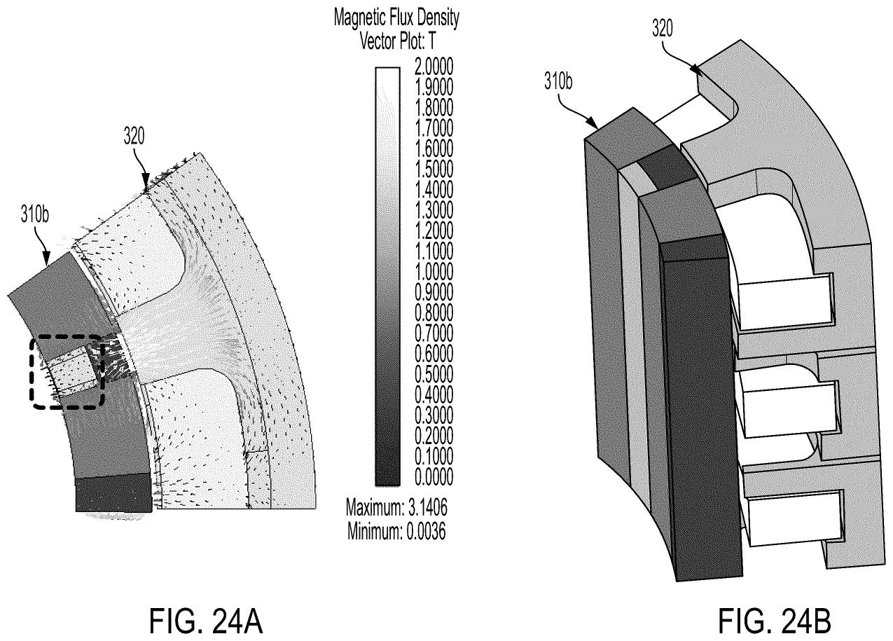

FIGS. 23A-23B show an internal rotor TFM, showing flux leakage opposite from the stator. The internal rotor TFM shown in FIGS. 23A-23B is a specific instance of the second TFM 300 with a thickness (TH)=3.0 mm. FIGS. 24A-24B show an internal rotor TFM, showing flux leakage opposite from the stator. The internal rotor TFM shown in FIGS. 24A-24B is a specific instance of the second TFM 300 with a thickness (TH)=5.0 mm. Furthermore, in both FIGS. 23A-23B and FIGS. 24A-24B the values of BetaCc and BetaDc are different. BetaCc is larger than BetaDc. Flux leakage may be reduced by making the concentrating core wider than the diverging core. Moreover, increasing BetaCc reduces magnet weight as well.

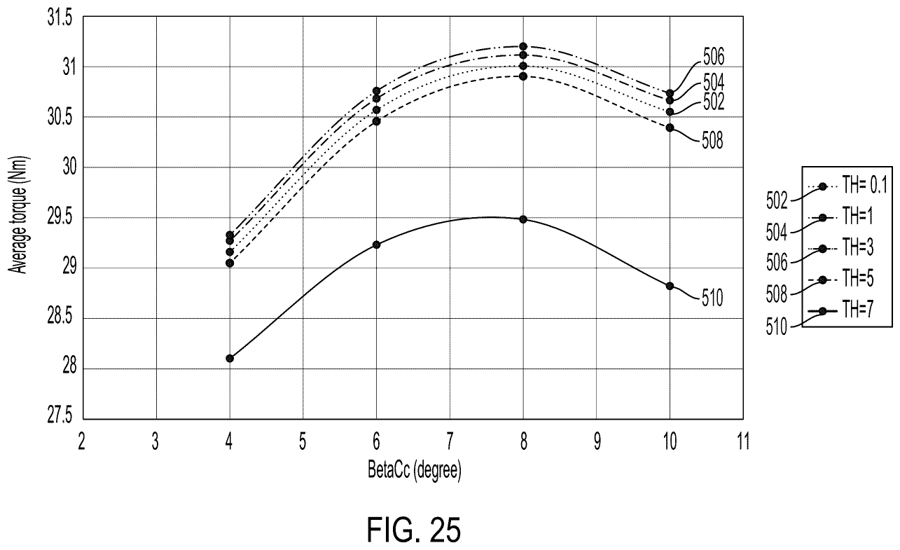

FIG. 25 shows a graph of Average torque (Nm) vs. BetaCc (degrees) of the second TFM 300 and for various thicknesses of non-magnetic material (TH). FIG. 25 includes a first plot 502 for the first non-magnetic portions 318 having thickness (TH)=0.1 mm. FIG. 25 also includes a second plot 504 for the first non-magnetic portions 318 having thickness (TH)=1.0 mm. FIG. 25 also includes a third plot 506 for the first non-magnetic portions 318 having thickness (TH)=3.0 mm. FIG. 25 also includes a fourth plot 508 for the first non-magnetic portions 318 having thickness (TH)=5.0 mm. FIG. 25 also includes a fifth plot 510 for the first non-magnetic portions 318 having thickness (TH)=7.0 mm. As shown, the first non-magnetic portions 318 having thickness (TH)=3.0 mm provides the highest average torque across the entire range of angular spreads (BetaCc).

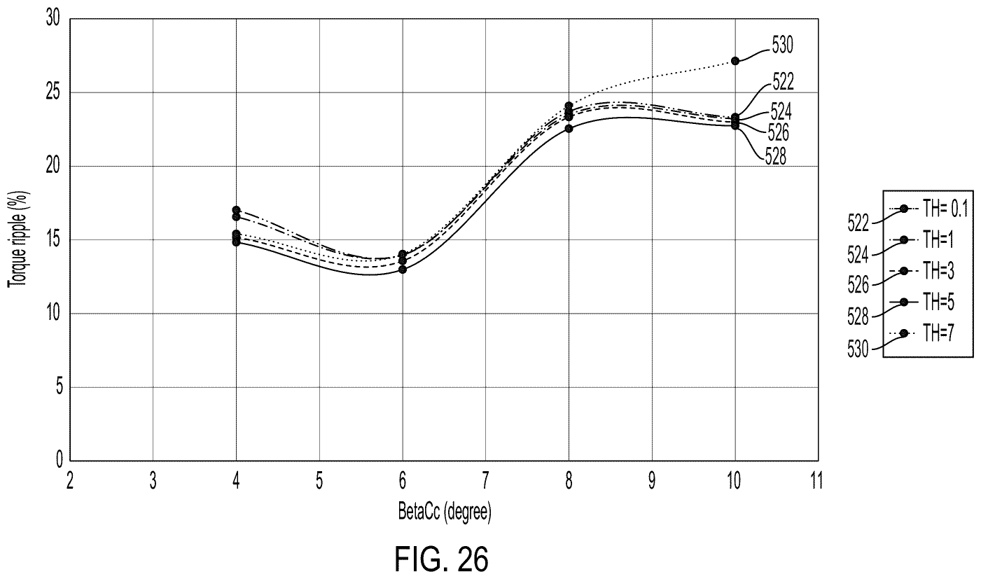

FIG. 26 shows a graph of Torque Ripple (%) vs. BetaCc (degrees) of the second internal rotor TFM and for various thicknesses of non-magnetic material (TH). FIG. 26 includes a first plot 522 for the first non-magnetic portions 318 having thickness (TH)=0.1 mm. FIG. 26 also includes a second plot 524 for the first non-magnetic portions 318 having thickness (TH)=1.0 mm. FIG. 26 also includes a third plot 526 for the first non-magnetic portions 318 having thickness (TH)=3.0 mm. FIG. 26 also includes a fourth plot 528 for the first non-magnetic portions 318 having thickness (TH)=5.0 mm. FIG. 26 also includes a fifth plot 530 for the first non-magnetic portions 318 having thickness (TH)=7.0 mm. As shown, the first non-magnetic portions 318 having thickness (TH)=5.0 mm provides the lowest torque ripple across the entire range of angular spreads (BetaCc).

The specific instance of the second TFM 300 shown in FIGS. 23A-23B is the design with the highest average torque from FIG. 25, and the specific instance of the second TFM 300 shown in FIGS. 24A-24B is the design with the with the lowest torque ripple from FIG. 26. As seen in FIGS. 23A-23B, 24A-24B, and 25-26, the impact of TH on average torque is low compared to the impact of BetaCc variation. With increasing TH value, the average torque increases, reaches a peak value and then drops off significantly with further increase. For torque ripple, the impact of BetaCc is more prominent.

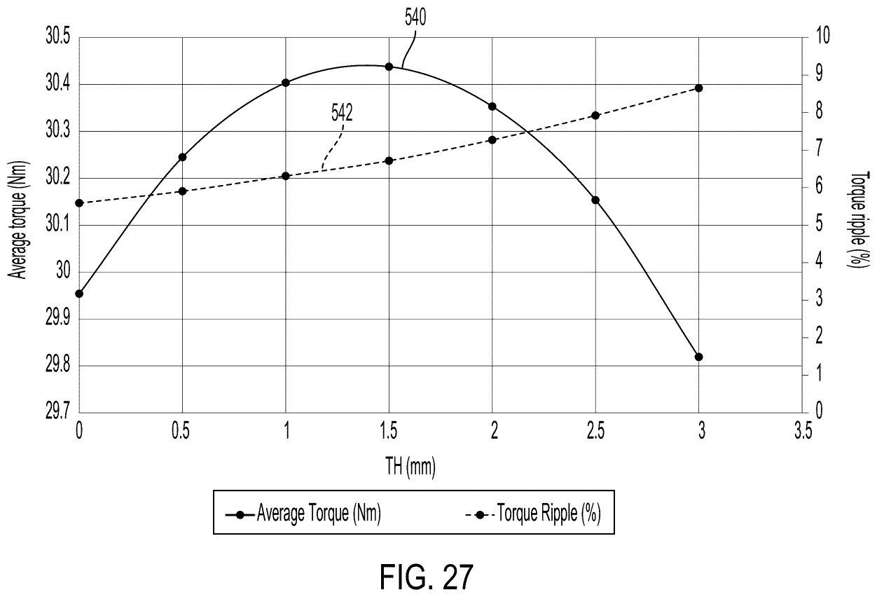

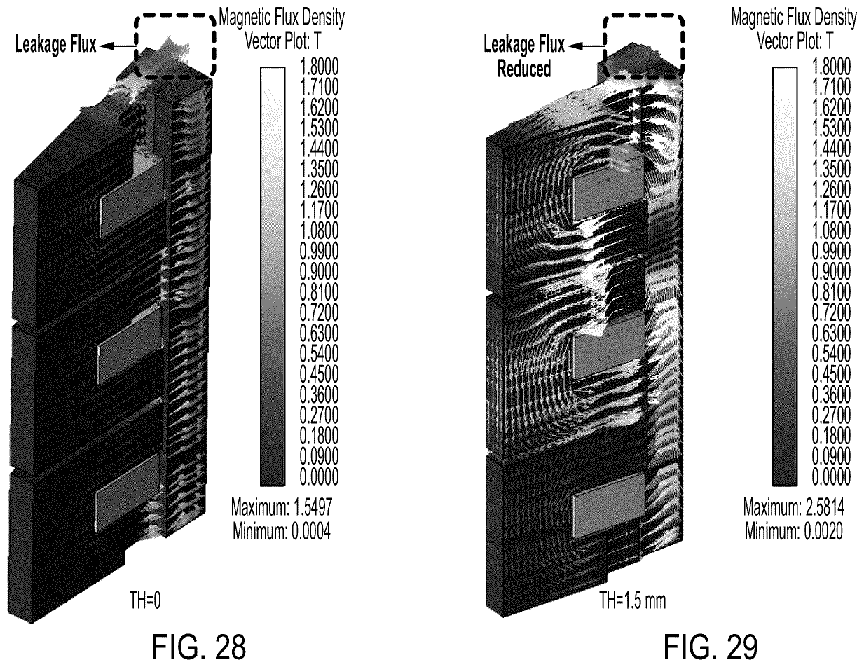

An outer rotor, 60-pole TFM is used to show the generic applicability of the proposed approach. First, TH is varied. FIG. 27 shows a first plot 540 of Average torque (Nm), and a second plot 542 of Torque Ripple (%) vs. thickness (TH) of non-magnetic material of an internal rotor TFM. FIG. 28 shows a shows a perspective fragmentary view of an internal rotor TFM of the present disclosure and with non-magnetic material thickness (TH) having a thickness TH=0 mm, showing leakage flux opposite from the stator; and FIG. 29 shows a shows a perspective fragmentary view of an internal rotor TFM of the present disclosure and with non-magnetic material (TH) having a thickness TH=1.5 mm, showing leakage flux opposite from the stator. FIG. 27 shows that with increasing TH, the average torque reaches a peak value and then starts to drop off with further increase. However, the torque ripple increases with TH as shown in FIG. 27. Therefore, careful combination of the three parameters (TH, BetaCc, BetaDc) may be considered to ensure better torque production. FIG. 29 shows the reduction in leakage flux with TH=1.5 mm.

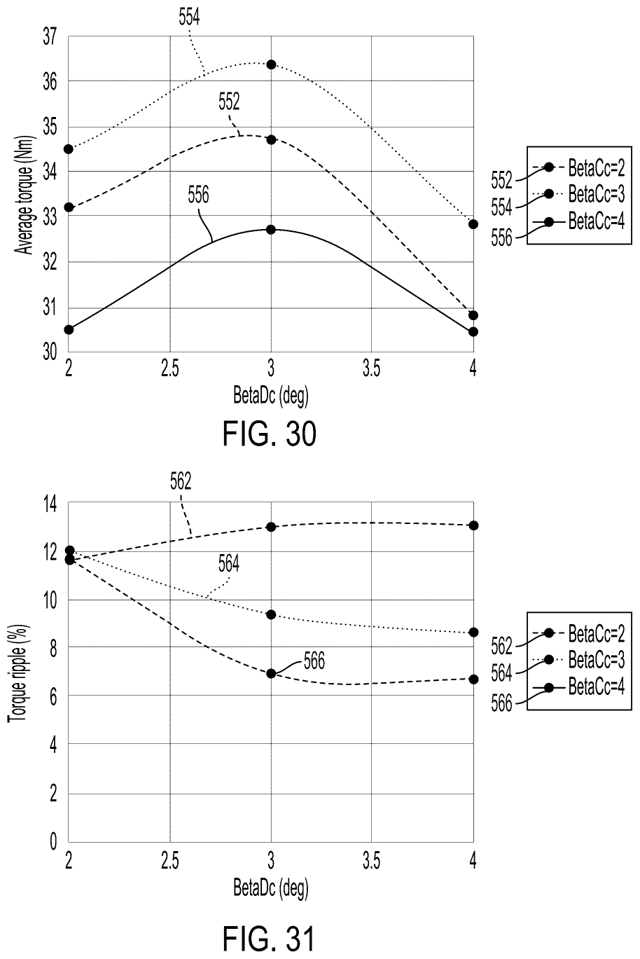

With the value of TH fixed at 1.5 mm, BetaCc and BetaDc are varied over a range to see the impact on average torque and torque ripple as presented in FIGS. 30-31. Impact of BetaCc and BetaDc on average torque follows the same trend.

FIG. 30 shows a graph of Average torque (Nm) vs. BetaDc (degrees) of an internal rotor TFM of the present disclosure and showing the impact of varying the second angular spread BetaDc of the second flux diverging cores 316 between 2.0 degrees and 4.0 degrees. FIG. 30 includes a first plot 552 showing impact of varying BetaDc and where BetaCc=2.0 degrees. FIG. 30 also includes a second plot 554 showing impact of varying BetaDc and where BetaCc=3.0 degrees. FIG. 30 also includes a third plot 556 showing impact of varying BetaDc and where BetaCc=4.0 degrees.

FIG. 31 shows a graph of Torque ripple (%) vs. BetaDc (degrees) of an internal rotor TFM of the present disclosure and showing the impact of varying the second angular spread BetaDc of the second flux diverging cores 316 between 2.0 degrees and 4.0 degrees. FIG. 31 includes a first plot 562 showing impact of varying BetaDc and where BetaCc=2.0 degrees. FIG. 31 also includes a second plot 564 showing impact of varying BetaDc and where BetaCc=3.0 degrees. FIG. 31 also includes a third plot 566 showing impact of varying BetaDc and where BetaCc=4.0 degrees.

With increasing BetaCc or BetaDc, the average torque reaches a peak value and then drops off. For low BetaCc value with increasing BetaDc the torque ripple increases. However, with higher BetaCc value the torque ripple decreases as BetaDc value increases. From the average torque perspective, a value of BetaCc=BetaDc=3 degrees (deg.) is preferable. However, this combination does not produce the best torque ripple performance. BetaCc=BetaDc=4 deg. produces the best torque ripple performance with poor average torque. An unequal value of BetaCc=4 deg., BetaDc=3 deg. produces similar torque ripple performance as the BetaCc=BetaDc=4 deg. case.

The analysis presented herein shows that each of the three design parameters, TH, BetaCc and BetaDc have the capability to increase average torque production and reduce torque ripple in the TFM irrespective of the configuration (outer or inner rotor) and pole number. Moreover, any value of TH above 0, makes the rotor lighter. The empty space created in the rotor by the introduction of TH can be filled by non-magnetic material like aluminum (like a sleeve around the rotor) which is much lighter than SMC. This significantly improves the gravimetric power density of the TFM. For example, for an optimized design with BetaCc=4.1 deg, BetaDc=3.9 deg, and TH=2 mm, the SMC weight in the rotor core reduces by 14.26% because of the introduction of TH.

### Fault Tolerant TFM

Steering is a safety critical application. To ensure safety during power failure conditions, redundancy of actuator systems is a popular solution. Dual wound PMSMs have been used in EPS systems for long. A dual wound TFM may provide redundancy and safety during power failure conditions. A dual wound TFM can be designed with the chosen TFM topology. An optimized version of the outer rotor TFM is chosen here to display the dual winding process.

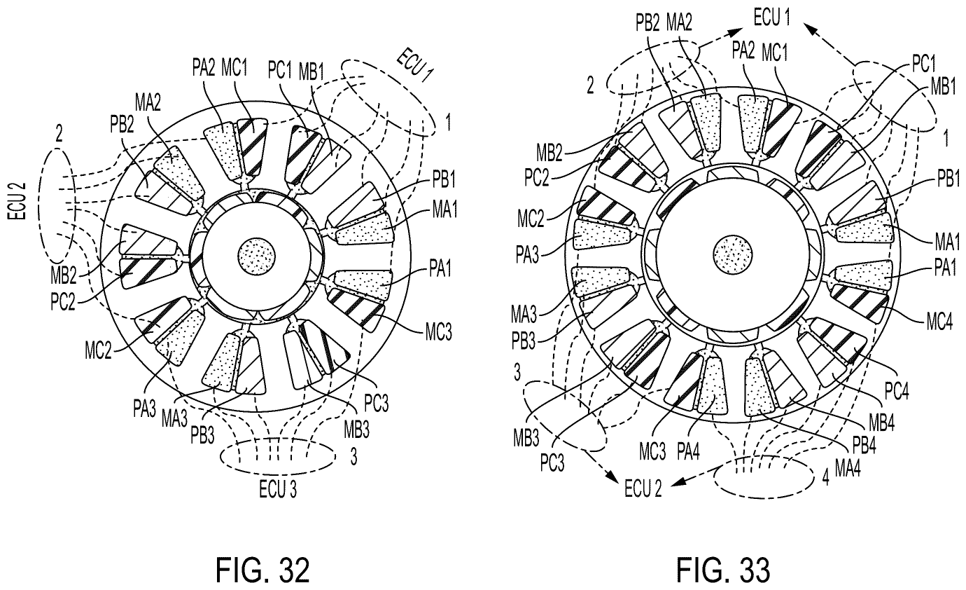

FIG. 32 shows a cross-sectional diagram of a dual wound PMSM with 3 phase groups in a 9 s/6 p configuration coupled to three different electronic control units (ECUs) labeled as ECU1, ECU2, and ECU3. FIG. 33 shows a cross-sectional diagram of a PMSM with 4 phase groups in a 12 s/8 p configuration coupled to two different ECUs. FIGS. 32-33 show examples of the popular 9 slot/6 pole and the 12 slot/8 pole PMSMs, where the winding on the stator can be divided into phase groups. For the 9 s/6 p PMSM three equivalent phase groups are seen, whereas for the 12 s/8 p four phase groups are identified. These phase groups can be sent to single/multiple electronic control units (ECUs)/inverters depending on the level of required redundancy.

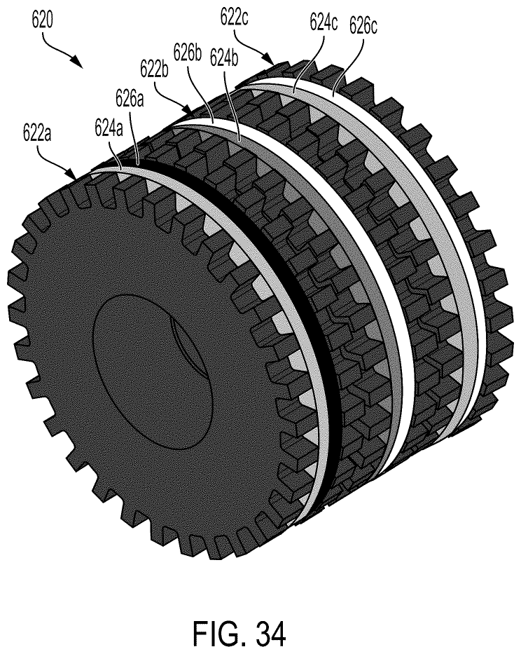

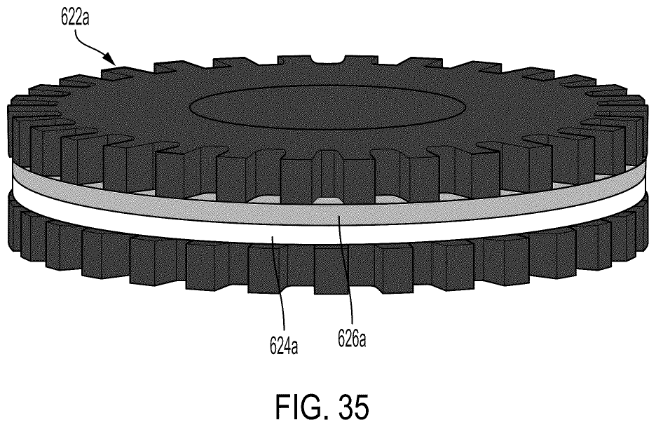

A dual wound TFM stator 620 having an external rotor configuration is shown in FIGS. 34-35. The dual wound TFM stator 620 may be similar or identical to the internal stator assembly 220 of the first TFM 200 except for differences described herein.

The dual wound TFM stator 620 includes three internal stator cores 622a, 622b, 622c, including an A-phase internal stator core 622a, a B-phase internal stator core 622b, and a C-phase internal stator core 622c. The three internal stator cores 622a, 622b, 622c each have similar or identical ring shapes that are stacked axially and shifted circumferentially from one-another. Each of the three internal stator cores 622a, 622b, 622c of the dual wound TFM stator 620 contains two corresponding ring windings 624a, 624b, 624c, 626a, 626b, 626c of a corresponding phase, and which extends circumferentially therethrough. In other words, each of the three internal stator cores 622a, 622b, 622c is a shared stator core holding two of the ring windings 624a, 624b, 624c, 626a, 626b, 626c. For example, a first A-phase ring winding 624a and a second A-phase ring winding 626a may each be disposed within the A-phase internal stator core 622a. The first A-phase ring winding 624a and the second A-phase ring winding 626a may each be connected to different corresponding ECUs, and either or both of the first A-phase ring winding 624a and/or the second A-phase ring winding 626a may be energized to generate a magnetic flux in the A-phase internal stator core 622a.

To clarify the placement of the windings, FIG. 35 shows a closer view of the A-phase internal stator core 622a, with the corresponding A-phase ring windings 624a, 626a. The first A-phase ring winding 624a and the second A-phase ring winding 626a are axially displaced, not radially (i.e. with same radial dimensions and locations), which may prevent resistance imbalance.

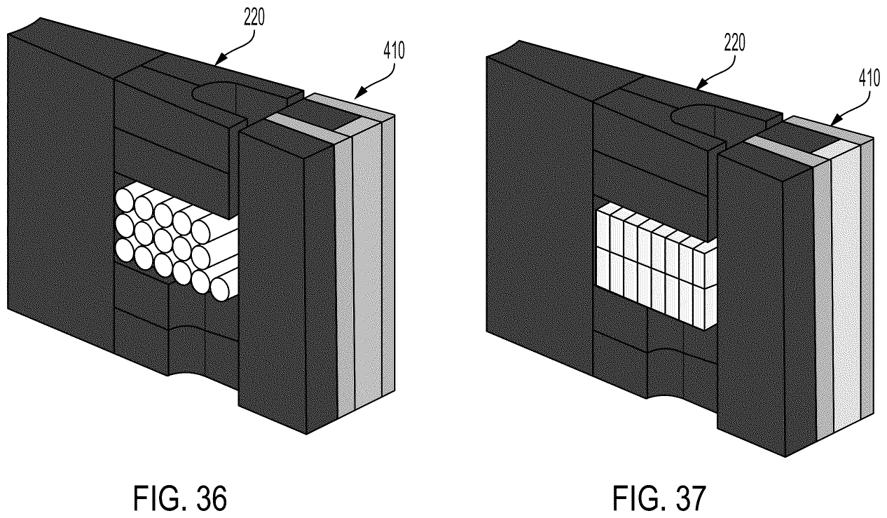

Impacts of wire type and size on the TFM winding process are shown in FIGS. 36-37. The outer rotor TFM has 16 turns in each stator. Both round and rectangular magnet wires can be used for the winding process. A 12 AWG round magnet wire is found to fit the available slot area with 16 turns as shown in FIG. 36. A 3.2544 mm×1.4478 mm rectangular wire is found off the shelf to fit the optimized TFM with 16 turns as shown in FIG. 37. As shown in FIG. 36, the turns of the round wire cannot be easily and symmetrically divided into two axial segments, thus making a dual-wound TFM configuration difficult with round wire. Accordingly, round wire may be more suitable for a single wound TFM configuration. However, as shown in FIG. 37, a dual wound TFM may include rectangular wire with 8 turns on each segment. The top and bottom layers of wire in the TFM in FIG. 37, have 8 turns each and can be sent to two identical inverters, such as ECU1, ECU2. A dual wound configuration can be achieved with the round wire as well by using thicker wire cross-sections. The dual winding configurations may be applicable to any TFM with ring windings on the stator.

The present disclosure provides a transverse flux machine (TFM) for a steer by wire handwheel actuator system. The proposed TFM has high volumetric and gravimetric power density with a simple ring-wound single piece per phase stator and a flux-concentrating rotor. The present disclosure also provides a method of flux leakage reduction which reduces magnet weight and cost, improves average torque and reduces torque ripple in the TFM. The present disclosure also provides a dual wound TFM structure to provide redundancy during power failure in the steering system.

An aspect of the disclosed embodiments includes a transverse flux machine (TFM). The TFM includes: a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core; and a stator including a transverse flux core configured to direct the magnetic flux in each of a radial direction and an axial direction. The rotor further includes a non-magnetic material located between the permanent magnets of each of the pairs of the permanent magnets, adjacent to the flux concentrating core and opposite from the stator, the non-magnetic material having a thickness (TH) in a radial direction.

In some embodiments, the TFM has an internal rotor configuration with the stator extending annularly about the rotor.

In some embodiments, the TFM has an external rotor configuration with the rotor extending annularly about the stator.

In some embodiments, wherein the rotor further includes a rotor housing with each of the plurality of pairs of permanent magnets, flux concentrating cores, and the flux diverging cores attached thereto, and the rotor housing protrudes in a radial direction to define the non-magnetic material located between the permanent magnets of each of the pairs of the permanent magnets.

In some embodiments, the TFM is a multi-phase machine, the transverse flux core is one of a plurality of stator cores each having a ring shape, and the plurality of stator cores are stacked axially and shifted circumferentially from one-another.

In some embodiments, the TFM further includes a first ring winding and a second ring winding each disposed in a shared stator core of the plurality of stator cores and each configured to conduct a corresponding current.

In some embodiments, the thickness (TH) of the non-magnetic material is at least about 1.5 mm.

In some embodiments, the flux concentrating core defines a first angular spread (BetaCc); the rotor further includes a flux diverging core located between adjacent pairs of the permanent magnets and defining a second angular spread (BetaDc); and the first angular spread (BetaCc) is not equal to the second angular spread (BetaDc).

In some embodiments, the first angular spread (BetaCc) is greater than the second angular spread (BetaDc).

An aspect of the disclosed embodiments includes a dual-wound transverse flux machine (TFM). The dual-wound TFM includes: a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core; a stator including a plurality of transverse flux cores, each of the transverse flux cores configured to direct the magnetic flux in each of a radial direction and an axial direction; and a first ring winding and a second ring winding each disposed in a shared transverse flux core of the plurality of transverse flux cores and each configured to conduct a corresponding current.

In some embodiments, the first ring winding and the second ring winding each include wires having a rectangular cross-section.

In some embodiments, the TFM has an internal rotor configuration with the stator extending annularly about the rotor.

In some embodiments, the TFM has an external rotor configuration with the rotor extending annularly about the stator.

In some embodiments, the TFM is a multi-phase machine, each transverse flux core of the plurality of transverse flux cores have a ring shape, and the plurality of transverse flux cores are stacked axially and shifted circumferentially from one-another.

An aspect of the disclosed embodiments includes a steer-by-wire system for a vehicle. The steer-by-wire system includes: a handwheel actuator coupled to apply a torque to a steering wheel. The handwheel actuator includes a transverse flux machine (TFM). The TFM includes: a rotor configured to rotate about an axis and having a plurality of pairs of permanent magnets, with a flux concentrating core located between the permanent magnets of each of the pairs of the permanent magnets; and a stator including a transverse flux core configured to direct a magnetic flux in each of a radial direction and an axial direction.

In some embodiments, the handwheel actuator is coupled to the steering wheel via a direct drive mechanism.

In some embodiments, the transverse flux core is one of a plurality of transverse flux cores, each having a ring shape, and

wherein the plurality of transverse flux cores are stacked axially and shifted circumferentially from one-another.

In some embodiments, the TFM further includes: a first ring winding and a second ring winding each disposed in a shared transverse flux core of the plurality of transverse flux cores and each configured to conduct a corresponding current.

In some embodiments, the rotor further includes a non-magnetic material located between the permanent magnets of each of the pairs of the permanent magnets, adjacent to the flux concentrating core and opposite from the stator, the non-magnetic material having a thickness (TH) in a radial direction.

In some embodiments, the flux concentrating core defines a first angular spread (BetaCc); the rotor further includes a flux diverging core located between adjacent pairs of the permanent magnets and defining a second angular spread (BetaDc); and the first angular spread (BetaCc) is not equal to the second angular spread (BetaDc).

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A transverse flux machine (TFM) comprising:
a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core; and
a stator including a transverse flux core configured to direct the magnetic flux in each of a radial direction and an axial direction,
wherein the rotor further includes a non-magnetic material located between the permanent magnets of each of the pairs of the permanent magnets, adjacent to the flux concentrating core and opposite from the stator, the non-magnetic material having a thickness (TH) in a radial direction.

2. The transverse flux machine of claim 1, wherein the TFM has an internal rotor configuration with the stator extending annularly about the rotor.

3. The transverse flux machine of claim 1, wherein the TFM has an external rotor configuration with the rotor extending annularly about the stator.

4. The transverse flux machine of claim 1, wherein the rotor further includes a rotor housing with each of the plurality of pairs of permanent magnets, flux concentrating cores, and the flux diverging cores attached thereto, and
wherein the rotor housing protrudes in a radial direction to define the non-magnetic material located between the permanent magnets of each of the pairs of the permanent magnets.

5. The transverse flux machine of claim 1, wherein the TFM is a multi-phase machine,
wherein the transverse flux core is one of a plurality of stator cores each having a ring shape, and
wherein the plurality of stator cores are stacked axially and shifted circumferentially from one-another.

6. The transverse flux machine of claim 5, further comprising: a first ring winding and a second ring winding each disposed in a shared stator core of the plurality of stator cores and each configured to conduct a corresponding current.

7. The transverse flux machine of claim 1, wherein the thickness (TH) of the non-magnetic material is at least about 1.5 mm.

8. The transverse flux machine of claim 1, wherein the flux concentrating core defines a first angular spread (BetaCc);
wherein the rotor further includes a flux diverging core located between adjacent pairs of the permanent magnets and defining a second angular spread (BetaDc); and
wherein the first angular spread (BetaCc) is not equal to the second angular spread (BetaDc).

9. The transverse flux machine of claim 8, wherein the first angular spread (BetaCc) is greater than the second angular spread (BetaDc).

10. A dual-wound transverse flux machine (TFM) comprising:
a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core;
a stator including a plurality of transverse flux cores, each of the transverse flux cores configured to direct the magnetic flux in each of a radial direction and an axial direction; and
a first ring winding and a second ring winding each disposed in a shared transverse flux core of the plurality of transverse flux cores and each configured to conduct a corresponding current.

11. The dual-wound transverse flux machine of claim 10, wherein the first ring winding and the second ring winding each include wires having a rectangular cross-section.

12. The dual-wound transverse flux machine of claim 10, wherein the TFM has an internal rotor configuration with the stator extending annularly about the rotor.

13. The dual-wound transverse flux machine of claim 10, wherein the TFM has an external rotor configuration with the rotor extending annularly about the stator.

14. The dual-wound transverse flux machine of claim 10, wherein the TFM is a multi-phase machine,
wherein each transverse flux core of the plurality of transverse flux cores have a ring shape, and
wherein the plurality of transverse flux cores are stacked axially and shifted circumferentially from one-another.

15. A steer-by-wire system for a vehicle, comprising:
a handwheel actuator coupled to apply a torque to a steering wheel;
the handwheel actuator including a transverse flux machine (TFM), including:
a rotor configured to rotate about an axis and having a plurality of pairs of permanent magnets, with a flux concentrating core and a flux diverging core having alternating placements between the permanent magnets of each of the pairs of the permanent magnets, with each of the pairs of permanent magnets arranged to generate a magnetic flux in a circumferential direction into the flux concentrating core and away from the flux diverging core; and
a stator including a transverse flux core configured to direct a magnetic flux in each of a radial direction and an axial direction.

16. The steer-by-wire system of claim 15, wherein the handwheel actuator is coupled to the steering wheel via a direct drive mechanism.

17. The steer-by-wire system of claim 15, wherein the transverse flux core is one of a plurality of transverse flux cores, each having a ring shape, and
wherein the plurality of transverse flux cores are stacked axially and shifted circumferentially from one-another.

18. The steer-by-wire system of claim 17, further comprising: a first ring winding and a second ring winding each disposed in a shared transverse flux core of the plurality of transverse flux cores and each configured to conduct a corresponding current.

19. The steer-by-wire system of claim 15, wherein the rotor further includes a non-magnetic material located between the permanent magnets of each of the pairs of the permanent magnets, adjacent to the flux concentrating core and opposite from the stator, the non-magnetic material having a thickness (TH) in a radial direction.

20. The steer-by-wire system of claim 15, wherein the flux concentrating core defines a first angular spread (BetaCc);
wherein the rotor further includes a flux diverging core located between adjacent pairs of the permanent magnets and defining a second angular spread (BetaDc); and
wherein the first angular spread (BetaCc) is not equal to the second angular spread (BetaDc).
